(19) United States
(12) Patent Application Publication
(10) Pub. No.: US 2007/0069548 A1
(43) Pub. Date: Mar. 29, 2007

(54) TWO-SHOT OVER-MOLD WITH RIBBED ARMREST

(75) Inventors: David J. Dooley, Troy, MI (US); Matthew S. Brummer, Canton, MI (US); Glenn A. Cowelchuk, Chesterfield Township, MI (US); Mark Loehr, Auburn Hills, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 11/162,925

(22) Filed: Sep. 28, 2005

(51) Int. Cl. B60J 5/00

(52) U.S. Cl. 296/146.7; 264/255

(57) ABSTRACT

A ribbed armrest for inclusion in an automobile door assembly includes a substrate section and a ribbed armrest section. The ribbed armrest section is over-molded onto the substrate section which provides support thereto. The ribbed armrest section includes a plurality of ribs that provide flexibility and a soft cushioned feel. A method of forming the ribbed armrest include a step in which the substrate is injection molded followed by a step in which the armrest section is injection molded onto the substrate section. Trim panels and door assemblies incorporating the ribbed armrest are also provided.

### BACKGROUND OF THE INVENTION

1. Field of the Invention

The present invention relates to ribbed armrests and in particular to ribbed armrests made by over-molding.

2. Background Art

Interior trim panels for automobiles that are aesthetically and tactilely pleasing to the vehicle occupants are desirable. Such trim panels commonly have cushioned soft-touch aesthetic features. In particular, interior vehicle door panels often have localized cushioned areas in the armrest. Such localized softness may be provided by a flexible foam or elastomeric pad of varying thickness typically mounted to a rigid structural substrate, and surrounded by a relatively harder durometer cover sheet.

It is also known to form vehicle armrests by placing a nibbed back surface of a molded vinyl skin against a rigid structural substrate, and clamping the vinyl skin to the underside of the substrate with a closure plate. However, such known methods of manufacturing vehicle armrests typically require a series of multiple and separate molding and assembly steps which can add significant cost to each part produced. Moreover, in some of the prior art method for forming such nibbed armrests separate layers are adhered together with adhesives which are difficult to align precisely and again add cost to the process.

Accordingly, there is a need for improved processes for forming ribbed tactilely pleasing armrests.

### SUMMARY OF THE INVENTION

The present invention overcomes one or more problems of the prior art by providing in one embodiment a ribbed armrest with a substrate section over-molded with a ribbed armrest section. Specifically, the substrate section is bonded to the ribbed armrest section with an over-molded bond as defined below. Both the ribbed armrest section and the substrate section of the ribbed armrest are made from resins. However, in many application the resin from which the substrate is formed is harder and more ridged than the resin from which the ribbed armrest section is formed. These differing characteristics stem from the differing functions for these components. The substrate provides support while the ribbed armrest section advantageously provides a soft cushioned feel.

In another embodiment of the invention, a method of making the ribbed armrest described above is provided. The method of this embodiment comprises positioning a first mold component and a second mold component to define a first mold cavity into which a first resin is subsequently introduced. Next, the first mold component and the second mold component are repositioned to form a second mold cavity. Characteristically, the second mold cavity has a ribbed mold section which is the inverse of a ribbed section of the armrest. A second resin into the second mold cavity to form an armrest layer. This armrest layer has a first section contacting at least a portion of the substrate and a second section having a plurality of ribs.

### BRIEF DESCRIPTION OF THE DRAWINGS

The following detailed description of the embodiments of the present invention can be best understood when read in conjunction with the following drawings, where like structure is indicated with like reference numerals and in which:

FIG. 1 is a side view of an automobile door assembly that incorporates an embodiment of the ribbed armrest of the present invention;

FIG. 2 is a cross-section of an embodiment of a ribbed armrest of the present invention;

FIG. 3A is a flowchart illustrating a method of forming a ribbed armrest by over-molding a ribbed armrest section over at least a portion of a substrate; and

FIG. 3B is a continuation of FIG. 3A.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE PREFERRED EMBODIMENT(S)

The following description of the preferred embodiments is merely exemplary in nature and is in no way intended to limit the invention, its application, or uses. Reference will now be made in detail to presently preferred compositions, embodiments and methods of the present invention, which constitute the best modes of practicing the invention presently known to the inventors. The figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for the claims and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of”, and ratio values are by weight; the term “polymer” includes “oligomer”, “copolymer”, “terpolymer”, and the like; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and to normal grammatical variations of the initially defined abbreviation; and, unless expressly stated to the contrary, measurement of a property is determined by the same technique as previously or later referenced for the same property.

As used herein, “over-molding” refers to the injection molding process in which a first material is molded onto a second material. When properly performed, the first material forms a strong bond with the second material without the use of primers or adhesives.

As used herein, “over-molded bond” refers to the bond between a first material and a second material when the first material is over-molded onto the second material. It should be appreciated that the precise nature of the over-molded bond will depend on the type of materials bonded together. For example, if two plastics are bonded together the over-molded bond is typically cohesive in nature. If a resin is bonded to a somewhat porous material like clothe, the resin tends to fill openings in the clothe to form a type of interlocking bond.

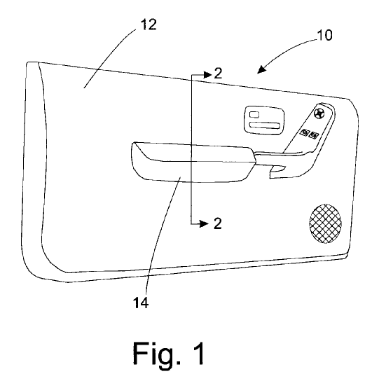

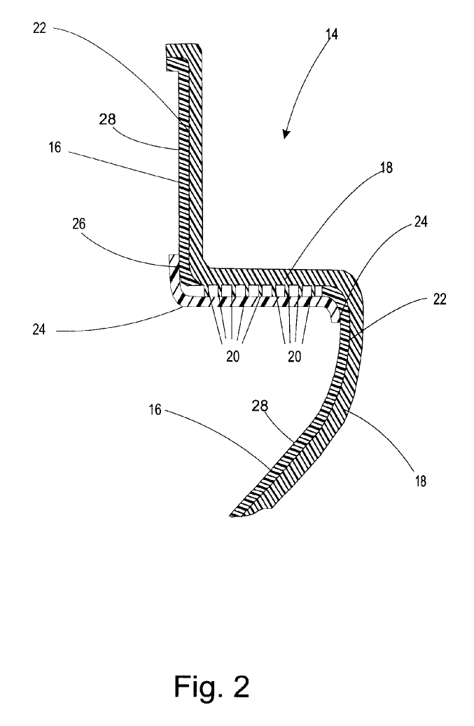

With reference to FIGS. 1 and 2, illustrations of an automobile trim, panel having an embodiment of a ribbed armrest of the present invention is provided. FIG. 1 provides a side view of an automobile door assembly that incorporates an embodiment of the ribbed armrest of the present invention. Automobile door assembly 10 comprises interior panel 12 which in turn includes ribbed armrest 14. FIG. 2 provides a cross-section of a ribbed armrest 14. Ribbed armrest 14 includes substrate section 16 and ribbed armrest section 18. Substrate section 16 may also be regarded as a substrate layer and ribbed armrest section 18 may be regarded as a ribbed armrest layer due to the layered configuration of ribbed armrest 14. Substrate section 16 provides support for ribbed armrest section 18. Although both ribbed armrest section 18 and substrate section 16 are typically formed from a resin, ribbed armrest section 18 is usually from a softer resin than substrate section 16. Moreover, substrate 16 is useful for attachment in automobile door assembly 10. Ribbed armrest section 18 includes plurality a of ribs 20 (also referred to as “nibs”) which extend from at least a portion of surface 22. Moreover, ribbed armrest section 18 is bonded to substrate section 16 with an over-molded bond as defined along another portion of surface 20. Ribbed armrest 14 also includes closeout 24 which is disposed over portions 24, 26 of surface 28 of substrate section 16 and over the region of ribbed armrest section 18 where plurality of ribs 20 are located. Specifically, closeout 24 is disposed over the ends of ribs 20.

As set forth above, substrate section 16 comprises a resin. Typically, useful resins are thermoplastic resins. Particularly useful resins include, for example, thermoplastic polyurethanes, thermoplastic olefins, polyvinyl chloride, polypropylene, and combinations thereof. More specific examples of useful resins include homopolymers and copolymers of polyethylene, homopolymers and copolymers of polypropylene, polycarbonate, acrylonitrile butadiene styrene, mixed acrylonitrile butadiene styrene and polycarbonate, and combinations thereof. Similarly, armrest section 18 is also formed from a resin, and in particular, a thermoplastic resin. Again, useful resins include, for example, thermoplastic polyurethanes, thermoplastic olefins, polyvinyl chloride, polypropylene, and combinations thereof. More specific examples of useful resins include homopolymers and copolymers of polyethylene, homopolymers and copolymers of polypropylene, polycarbonate, acrylonitrile butadiene styrene, mixed acrylonitrile butadiene styrene and polycarbonate, and combinations thereof. Since armrest section 18 is usually softer than substrate section 16, armrest section 18 may also comprise elastomers. Examples of useful elastomers include thermoplastic elastomers, styrene-ethylene-butylene-styrene elastomers, blocked copolymer thermoplastic elastomers, polyolefin-based elastomers, foamed thermoplastic elastomers, and combinations thereof.

In another embodiment of the present invention, a method of forming the ribbed automobile door armrest set forth above is provided. The ribbed armrest is made by a molding process executed in a molding system. Injection molding is particularly useful for forming the ribbed armrests of the invention.

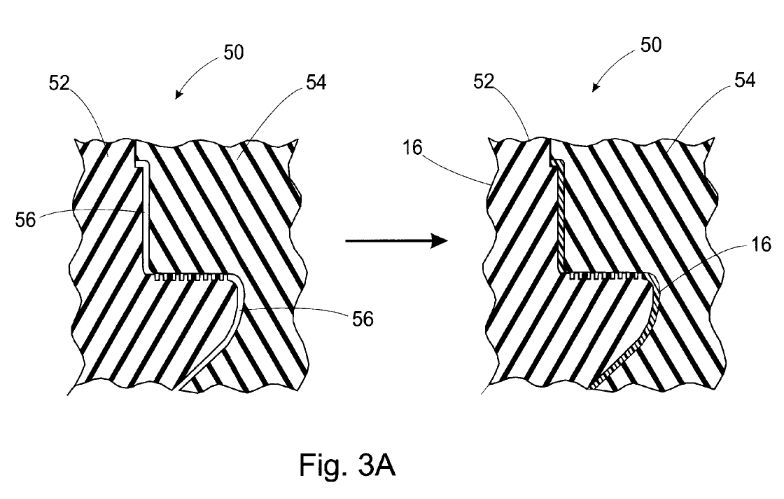

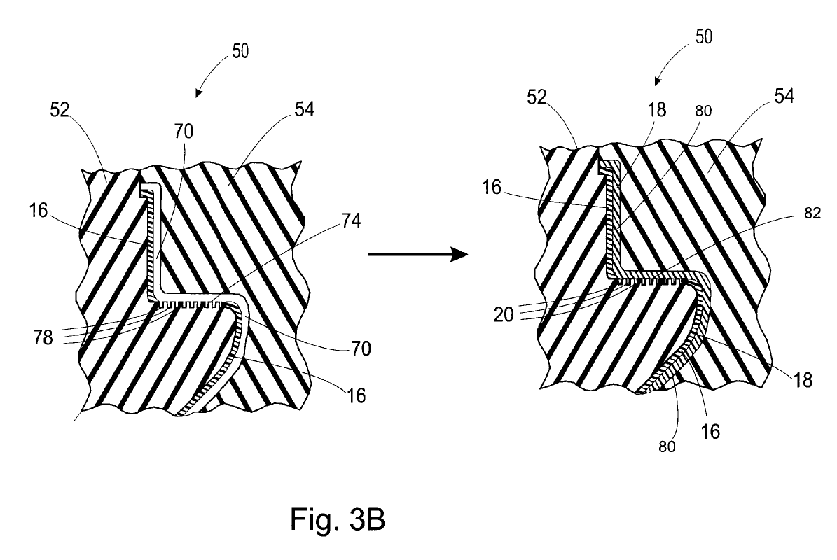

With reference to FIGS. 1, 2, 3A, and 3B, the methods of molding the ribbed armrest of the invention are illustrated. Molding system 50 includes first mold component 52 and second mold 54. First mold component 52 and second mold component 54 are positioned to define first mold cavity 56. A first resin is introduced into first mold cavity 56 to form substrate section 16. Typically, the first resin is injected into first mold cavity 56 at a temperature from about 350° F. to about 440° F. and a pressure from about 700 psi to about 2100 psi. It should be appreciated that these temperature and pressure ranges will vary depending on the materials used. Next, first mold component 52 and second mold component 54 are positioned to form second mold cavity 70. It should be appreciated that first mold component 52 and second mold component 54 may include moveable sections that are individually positionable to form second mold cavity 70. Alternatively, second mold component 54 may be replaced with a substitute mold component specifically designed to form second mold cavity 70. The second mold cavity has a ribbed mold section that is the inverse of ribbed armrest section 18. Moreover, surface 74 of second mold cavity 70 includes a plurality of rib grooves 78. A second resin is then introduced into the second mold cavity to form ribbed armrest section 18. Ribbed armrest section 18 includes first section 80 which contacts at least a portion of substrate section 16, and second section 82 having a plurality of ribs 20 as set forth above. Typically, the second resin is injected into second mold cavity 70 at a temperature from about 350° F. to about 440° F. and a pressure from about 700 psi to about 2100 psi. It should be appreciated that these temperature and pressure ranges will vary depending on the materials used. Ribbed armrest section 18 in accordance with the method of this embodiment is over-molded over at least a portion of substrate section 16. Accordingly, armrest section 18 is bonded to substrate section 16 with an over-molded bond as defined above.

In accordance with the method of this embodiment, the first resin forms substrate section 16. Accordingly, useful resins for the first resin are thermoplastic resins. Particularly useful resins include, for example, thermoplastic polyurethanes, thermoplastic olefins, polyvinyl chloride, polypropylene, and combinations thereof. More specific examples of useful resins include homopolymers and copolymers of polyethylene, homopolymers and copolymers of polypropylene, polycarbonate, acrylonitrile butadiene styrene, mixed acrylonitrile butadiene styrene and polycarbonate, and combinations thereof. Similarly, the second resin is used to form rubber armrest section 18. Again, useful resins for the second resin include, for example, thermoplastic polyurethanes, thermoplastic olefins, polyvinyl chloride, polypropylene, and combinations thereof. More specific examples of useful resins include homopolymers and copolymers of polyethylene, homopolymers and copolymers of polypropylene, polycarbonate, acrylonitrile butadiene styrene, mixed acrylonitrile butadiene styrene and polycarbonate, and combinations thereof. Since armrest section 18 is usually softer than substrate section 16, the second resin may also comprise elastomers. Examples of useful elastomers include thermoplastic elastomers, styrene-ethylene-butylene-styrene elastomers, blocked copolymer thermoplastic elastomers, polyolefin-based elastomers, foamed thermoplastic elastomers, and combinations thereof.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of forming a ribbed automobile door armrest in a molding system having a first mold component and a second mold, the method comprising:
a) positioning the first mold component and the second mold component to define a first mold cavity;
b) introducing a first resin into the first mold cavity to form a substrate;
c) positioning the first mold component and the second mold component to form a second mold cavity, the second mold cavity having a ribbed mold section which is the inverse of a ribbed section of the armrest; and
d) introducing a second resin into the second the mold cavity to form an armrest section, the armrest section having a first section contacting at least a portion of the substrate and a second section having a plurality of ribs.

2. The method of claim 1 wherein the first resin comprises a thermoplastic resin.

3. The method of claim 2 wherein the first resin is injected into the first mold cavity at a temperature from about 350° F. to about 440° F. and a pressure from about 700 psi to about 2100 psi.

4. The method of claim 2 wherein the first resin comprises a component selected from the group consisting of thermoplastic polyurethanes, thermoplastic olefins, polyvinyl chloride, polypropylene, and combinations thereof.

5. The method of claim 2 wherein the first resin comprises a component selected from the group consisting of homopolymers and copolymers of polyethylene, homopolymers and copolymers of polypropylene, polycarbonate, acrylonitrile butadiene styrene, mixed acrylonitrile butadiene styrene and polycarbonate, and combinations thereof.

6. The method of claim 1 wherein the second resin comprises a component selected from thermoplastic resins.

7. The method of claim 6 wherein the second resin is injected into the first mold cavity at a temperature from about 350° F. to about 440° F. and a pressure from about 700 psi to about 2100 psi.

8. The method of claim 6 wherein the second resin comprises a component selected from the group consisting of homopolymers and copolymers of polyethylene, homopolymers and copolymers of polypropylene, thermoplastic olefins, thermoplastic urethanes, polycarbonate, acrylonitrile butadiene styrene, mixed acrylonitrile butadiene styrene and polycarbonate, and combinations thereof.

9. The method of claim 6 wherein the second thermoplastic resin is selected from the group consisting of thermoplastic elastomers, styrene-ethylene-butylene-styrene elastomers, blocked copolymer thermoplastic elastomers, polyolefin-based elastomers, foamed thermoplastic elastomers, and combinations thereof.

10. The method of claim 1 further comprising attaching a closeout to the armrest layer.

11. An automobile door assembly comprising the armrest made by the method of claim 1.

12. A molding system for implementing the method of claim 1.

13. An automobile trim panel comprising:
a substrate section for attachment to an automobile door frame;
a ribbed armrest section bonded to the substrate section with an over-molded bond, the ribbed armrest section having a region with a plurality of ribs; and
a closeout disposed over a portion of the substrate section and over the region with a plurality of ribs.

14. The trim panel of claim 13 wherein the substrate section comprises a thermoplastic resin.

15. The trim panel of claim 14 wherein the substrate section comprises a component selected from the group consisting of thermoplastic polyurethanes, thermoplastic olefins, polyvinyl chloride, polypropylene, and combinations thereof.

16. The trim panel of claim 14 wherein the substrate section comprises a component selected from the group consisting of homopolymers and copolymers of polyethylene, homopolymers and copolymers of polypropylene, thermoplastic olefins, thermoplastic urethanes, polycarbonate, acrylonitrile butadiene styrene, mixed acrylonitrile butadiene styrene and polycarbonate, and combinations thereof.

17. The trim panel of claim 14 wherein the armrest section comprises components selected from thermoplastic resins.

18. The trim panel of claim 17 wherein the armrest section comprises a component selected from the group consisting of homopolymers and copolymers of polyethylene, homopolymers and copolymers of polypropylene, thermoplastic olefins, thermoplastic urethanes, polycarbonate, acrylonitrile butadiene styrene, mixed acrylonitrile butadiene styrene and polycarbonate, and combinations thereof.

19. The trim panel of claim 17 wherein the armrest section is selected from the group consisting of thermoplastic elastomers, styrene-ethylene-butylene-styrene elastomers, blocked copolymer thermoplastic elastomers, polyolefin-based elastomers, foamed thermoplastic elastomers, and combinations thereof.
